(19) United States
(12) Patent Application Publication
(10) Pub. No.: US 2026/0179370 A1
(43) Pub. Date: Jun. 25, 2026

(54) EVALUATING IMAGE DATA FOR ONE OR MORE IMPERFECTIONS USING A VISION LANGUAGE MODEL

(71) Applicant: NVIDIA Corporation, Santa Clara, CA (US)

(72) Inventor: Julien Francois JOMIER, Chapel Hill, NC (US)

(73) Assignee: NVIDIA Corporation, Santa Clara, CA (US)

(21) Appl. No.: 19/001,004

(22) Filed: Dec. 24, 2024

(51) Int. Cl. G06V 10/82; G06T 7/00; G06T 7/11; G06V 10/70; G06V 10/77; G06V 20/70

(52) U.S. Cl. CPC G06V 10/82; G06T 7/0002; G06T 7/11; G06V 10/768; G06V 10/7715; G06V 20/70; G06T 2207/20081; G06T 2207/20084; G06T 2207/30168

(57) ABSTRACT

In various examples, systems and methods are disclosed that relate to the evaluation of image data for imperfections using a vision language model (VLM). For example, a system can be configured to obtain image data associated with at least one image that includes one or more imperfections. The system can determine a query based at least on the at least one image that is usable to prompt the VLM when processing the image data. In some embodiments, the system can provide the image data and the query to the VLM to cause the VLM to generate the output in accordance with the query, indicating whether one or more imperfections are present in the at least one image.

### BACKGROUND

Various systems can be used to generate and output images or videos across a variety of use cases. For example, a system involved in laparoscopic surgical procedures can include a camera that generates images of the surgical field during surgical procedures. In another example, a system (e.g., a computer, a console, and/or the like) can render images when generating interactive media. These images (also referred to in association with frames) can then be used for a variety of purposes including real-time playback and model training (e.g., for segmentation, classification, etc.). But for a variety of reasons, these images can suffer from image degradation that is undesirable or, in some cases, negatively impacts downstream use of the images. For example, cameras used to generate images or video of a surgical field can introduce noise, blur, distortion, and/or the like as a result of improper configuration or issues with the sensor of the camera. In other examples, artifacts can be introduced when using lossy compression techniques. Further, some degraded images can be subject to chromatic aberration, vignetting, aliasing, and/or the like.

### SUMMARY

Embodiments of the present disclosure relate to evaluation of image data for one or more imperfections. More specifically, in some embodiments, systems and methods are disclosed that involve validating image data for one or more imperfections using a vision language model (VLM) and queries that configure the VLM to indicate whether one or more imperfections are present in the image data.

In instances where images vary (e.g., from frame to frame in a video), degradation can be intermittent. To identify these imperfections, manual review of the images or video can be implemented to identify those including one or more imperfections. However, this review can be subjective and reliant on the expertise of the human observer in identifying such imperfections. And in instances where datasets are being curated to train and/or update models, these processes can be unscalable as millions or billions of images may need to be reviewed. Similarly, in other instances where images are checked for corruption when transmitted between devices, systems can be configured to use checksums to ensure that the images are not degraded (e.g., when compressed, in flight, etc.). In these cases, the checksum is determined using a function (similar to a hash) and the output of the function is appended to the image (e.g., before or after compression) as a fixed-size string of bytes. The device that receives the image can then recalculate the checksum based at least on the image that is received and can compare the recalculated checksum to the original. Due to the sensitivity of this approach, deviation between the pixels of the original image and the received image can result in determinations that the image is corrupted. While additional techniques can be implemented to allow for some deviation (e.g., through creation of a set of baseline images for comparison), this is computationally inefficient, requiring the pre-computation and storage of many baseline images and knowledge of a known set of input frames.

When implemented, the techniques described herein address the deficiencies of the above-discussed techniques and allow for a more broadly applicable and flexible approach to image (frame) validation. For example, systems configured to analyze images as described herein can more consistently identify degraded images having one or more imperfections, such as images that are grainy, blurry, are associated with incorrect annotations or labels, etc. In some instances, this can allow for the identification and removal of these images from training datasets prior to model training and/or updating, reducing both the chances of performance degradation of the models being trained and/or updated and the time and computing resources involved in training and/or updating these models. Additionally, by analyzing images using a VLM as opposed to other techniques (e.g., the use of checksums), some embodiments of the systems can forgo identifying images as degraded when subject to expected (but acceptable) degradation (due to, for example, the implementation of lossy compression techniques). This can reduce the consumption of network resources (e.g., memory and processing cycles) involved in re-requesting the images that are degraded through the compression process and/or the maintaining baseline images to compare against the generated images, while also allowing for introduction of random testing (e.g., the use of synthetic images or images from a new testing set).

Some systems can be configured to obtain image data associated with at least one images and provide the image data and a query to a VLM to cause the VLM to generate an output. The output can include a text string indicating that the at least one image includes one or more imperfections (e.g., grainy or blurry features within the image, incorrect annotations, etc.). The output of the VLM can then be used to determine a degree of quality that indicates whether the images are suitable/not suitable for a downstream use (e.g., model training and/or updating), whether a system that generated the images is or is not performing as expected, etc.

At least one aspect relates to one or more processors. The one or more processors can include one or more circuits to obtain image data associated with at least one (e.g. each) image that includes one or more imperfections. In some implementations, the one or more circuits can determine a query based at least on the at least one image. The query can be configured to prompt a vision language model (VLM) to generate an output indicative of the one or more imperfections of the at least one image. In some implementations, the one or more circuits can provide the image data and the query to the VLM to prompt the VLM to generate the output. The one or more circuits can provide data on a degree of quality of the at least one image associated with the one or more imperfections, according to the output of the VLM.

In some implementations, the one or more circuits can determine a context based at least on a feature of the at least one image. To determine the query, the one or more circuits can determine a set of strings associated with the context, and determine the query based at least on the set of strings. The query can be configured to cause the VLM to generate the output to include a text string indicative of the feature. In some implementations, the one or more circuits that determine the context can determine the context using a context for at least another image occurring prior to the at least one image in time or in a sequence.

In implementations, the one or more circuits that determine the query can determine the query from a plurality of queries, where each of the queries is configured to cause the VLM to indicate a degradation from among a plurality of imperfections. The plurality of imperfections can include noise, blur, distortion, artifacts, chromatic aberration, vignetting, or aliasing, etc. In some implementations, one or more (e.g., each) image of the at least one image can include a two-dimensional (2D) image represented using a 2D array of pixels. The one or more pixels can be associated with a first channel and a second channel. In examples, the one or more circuits that determine the query based at least on the at least one image can determine the query based at least on the first channel or the second channel.

In at least some implementations, the first channel can be associated with a first portion of an electromagnetic spectrum, and the second channel can be associated with a second portion of the electromagnetic spectrum that is at least in part different from the first portion of the electromagnetic spectrum. In some examples, the one or more circuits that provide the image data and the query to the VLM can provide a portion of the image data associated with the first channel or the second channel to the VLM to cause the VLM to generate the output. The one or more circuits that determine the query can determine the query based at least on annotations of the at least one image.

In implementations, one or more (e.g., each) image of the at least one image can be represented by a plurality of pixels associated with a first channel corresponding to pixel values and a second channel corresponding to annotations. In examples, the one or more circuits that determine the query are determine the query such that the query can be configured to prompt the VLM to indicate mismatches between annotations indicative of segmentation errors.

In some implementations, the query can include a first query, the output can include a first output, and the one or more imperfections can include one or more first imperfections. In examples, the one or more circuits can determine that the first output indicates that the at least one image includes the one or more first imperfections, and can determine a second query based at least on the one or more first imperfections. The second query can be configured to prompt the VLM to indicate that one or more second imperfections are present in the at least one image, and can provide the image data and the second query to the VLM to cause the VLM to generate a second output. The second output can indicate that the at least one image includes the one or more second imperfections, and can determine the degree of quality associated with the at least one image according to the second output.

In some implementations, the one or more processors are included in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system for performing generative AI operations; a system for implementing vision language models (VLMs); a system for implementing large language models (LLMs); a system for implementing small language models (SLMs); a system for implementing multi-modal language models, a system for hosting one or more real-time streaming applications; a system for performing light transport simulation; a system for performing collaborative content creation for 3D assets; or a system implemented at least partially using cloud computing resources.

At least one aspect relates to a system. The system can include one or more processors to perform operations. In some implementations, the operations can include receiving image data associated with at least one image that includes one or more imperfections. The operations can include determining a query based at least on the at least one image. The query can be configured to prompt a vision language model (VLM) to generate an output indicative of the one or more imperfections of the at least one image. In some implementations, the operations can include providing the image data and the query to the VLM to prompt the VLM to generate the output. The operations can include providing data on a degree of quality of the at least one image associated with the one or more imperfections, according to the output of the VLM.

In at least some implementations, the one or more processors can perform operations to determine a context based at least on a feature of the at least one image. In The one or more processors that determine the query can determine the query by determining a set of strings associated with the context and determining the query based at least on the set of strings. The query can be configured to cause the VLM to generate the output to include a text string indicative of the feature.

In some implementations, the one or more processors that determine the context can determine a context for at least another image occurring prior to the at least one image in time or in a sequence. In some implementations, the one or more processors can determine the query by determining the query from a plurality of queries. One or more of (e.g., each) of the queries can be configured to cause the VLM to indicate a degradation from among a plurality of imperfections including: noise, blur, distortion, artifacts, chromatic aberration, vignetting, or aliasing. In some implementations, one or more (e.g., each) image of the at least one image can include a two-dimensional (2D) image represented using a 2D array of pixels. One or more (e.g., each) pixel can be associated with a first channel and a second channel. The one or more processors can determine the query based at least on the at least one image by determining the query based at least on the first channel or the second channel.

In implementations, the first channel can be associated with a first portion of an electromagnetic spectrum. The second channel can be associated with a second portion of the electromagnetic spectrum that is at least in part different from the first portion of the electromagnetic spectrum. In some implementations, the one or more processors can provide the image data and the query to the VLM by providing a portion of the image data associated with the first channel or the second channel to the VLM to cause the VLM to generate the output. In implementations, the one or more processors can determine the query based at least on annotations. The annotations can include annotations to the at least one image.

In some implementations, each image of the at least one image can be represented by a plurality of pixels. Each pixel of the plurality of pixels can be associated with a first channel corresponding to pixel values and a second channel corresponding to annotations. In some implementations, the one or more processors are to perform the operation of determining the query by determining the query such that the query is configured to prompt the VLM to indicate mismatches between annotations indicative of segmentation errors.

In some aspects, the system is included in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system for performing generative AI operations; a system for implementing vision language models (VLMs); a system for implementing large language models (LLMs); a system for implementing small language models (SLMs); a system for implementing multi-modal language models; a system for hosting one or more real-time streaming applications; a system for performing light transport simulation; a system for performing collaborative content creation for 3D assets; or a system implemented at least partially using cloud computing resources.

At least one aspect relates to a method. In some implementations, the method includes receiving image data associated with at least one image that includes one or more imperfections, and determining a query based at least on the at least one image. The query can be configured to prompt a vision language model (VLM) to generate an output indicative of the one or more imperfections of the at least one image. The method can include providing the image data and the query to the VLM to prompt the VLM to generate the output, and providing data on a degree of quality of the at least one image associated with the one or more imperfections, according to the output of the VLM.

### BRIEF DESCRIPTION OF THE DRAWINGS

The present systems and methods for automation of visual quality assurance using vision language models are described in detail below with reference to the attached drawing figures, wherein:

FIG. 1 is an example computing environment in which one or more devices operate to evaluate image data for one or more imperfections, in accordance with some embodiments of the present disclosure;

FIG. 2 is a flow diagram of an example method for evaluating image data for one or more imperfections, in accordance with some embodiments of the present disclosure;

FIG. 3 is a flow diagram showing an implementation involving evaluation of image data for one or more imperfections, in accordance with some embodiments of the present disclosure;

FIG. 4 is an example scene of a real-world application involving evaluation of image data for one or more imperfections, in accordance with some embodiments of the present disclosure;

FIG. 5 is an example scene of an imaging device producing image data that includes one or more imperfections, in accordance with some embodiments of the present disclosure;

FIG. 6A is an example of a computer-generated image that does not one or more imperfections, in accordance with some embodiments of the present disclosure;

FIG. 6B is an example of a computer-generated image that includes one or more imperfection, in accordance with some embodiments of the present disclosure;

FIG. 7A is a block diagram of an example generative language model system suitable for use in implementing some embodiments of the present disclosure;

FIG. 7B is a block diagram of an example generative language model that includes a transformer encoder-decoder suitable for use in implementing some embodiments of the present disclosure;

FIG. 7C is a block diagram of an example generative language model that includes a decoder-only transformer architecture suitable for use in implementing some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Systems and methods are disclosed related to the evaluation of image data for one or more imperfections. For example, a system can obtain image data associated with at least one image that includes one or more imperfections and determine a query based at least on the at least one image. The query can be configured to prompt a vision language model (VLM) to generate an output indicative of the one or more imperfections of the at least one image. The method can then include providing the image data and the query to the VLM to prompt the VLM to generate the output, and providing data on a degree of quality of the at least one image associated with the one or more imperfections, according to the output of the VLM.

By causing the VLM to generate an output including information about the imperfections of the at least one image, the methods described herein allow for the generation of more accurate indications of the imperfections in an image when compared to other techniques. For example, the VLM output responsive to the image and the query can include specific indications of the imperfections of the image, such as whether the image is grainy, etc. Additionally, by analyzing the image data using the VLM, the sensitivity of the systems and methods for analyzing image quality can be adjusted for particular use cases. For example, when compared to methods involving the analysis of image quality by computing a hash of the at least one images being analyzed, the present disclosure reduces the chances that images with subtle imperfections will be flagged as needing to be removed from training datasets, re-obtained, reconstructed, etc. This both conserves computing resources (e.g., processing and memory resources) and networking resources (e.g., resources dedicated to additional network bandwidth consumption) when compared to conventional techniques.

Further, by virtue of producing these responses and the data on the degree of quality of images, larger amounts of image data can be processed in a shorter amount of time when the computing devices involved are configured as described herein, making the review process more efficient and freeing dedicated resources faster than conventional techniques. The systems can generate responses to queries and determine data on the degree of quality more consistently. For example, using human reviewers can require a plurality of people to review image data. In this example, each human reviewer in the plurality of people can give different output when given the same image data. By contrast, systems and methods described herein can produce repeatable results when generating data on the degree of quality, improving the consistency with which images with imperfections are addressed as well as the speed with which datasets of images can be processed.

The systems and methods described herein can be used for a variety of purposes, by way of example and without limitation, for machine control, machine locomotion, machine driving, synthetic data generation, model training and/or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications. Disclosed embodiments can be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

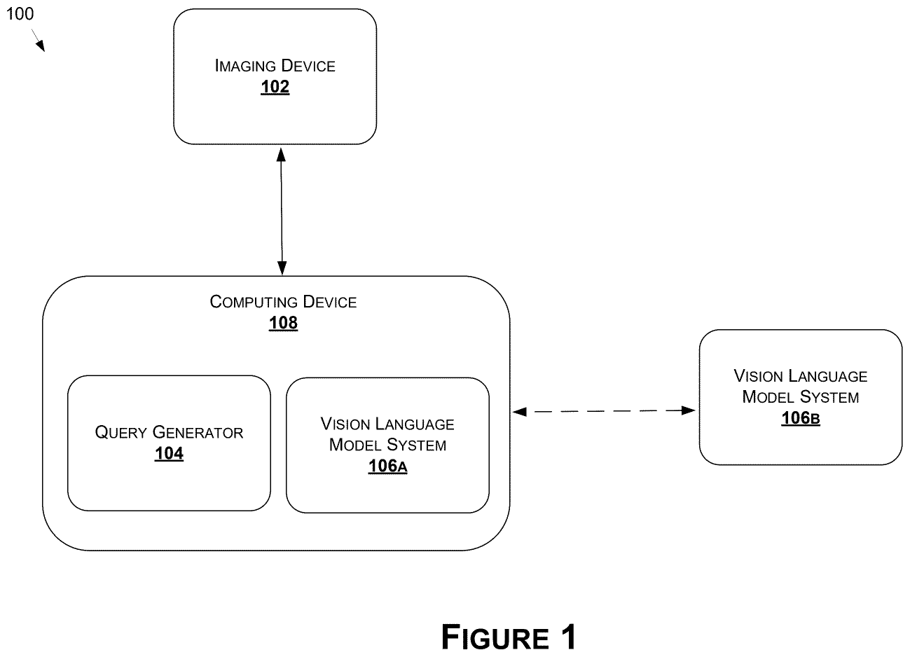

With reference to FIG. 1, FIG. 1 is an example computing environment 100 in which one or more devices can operate to generate and/or evaluate image data, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory.

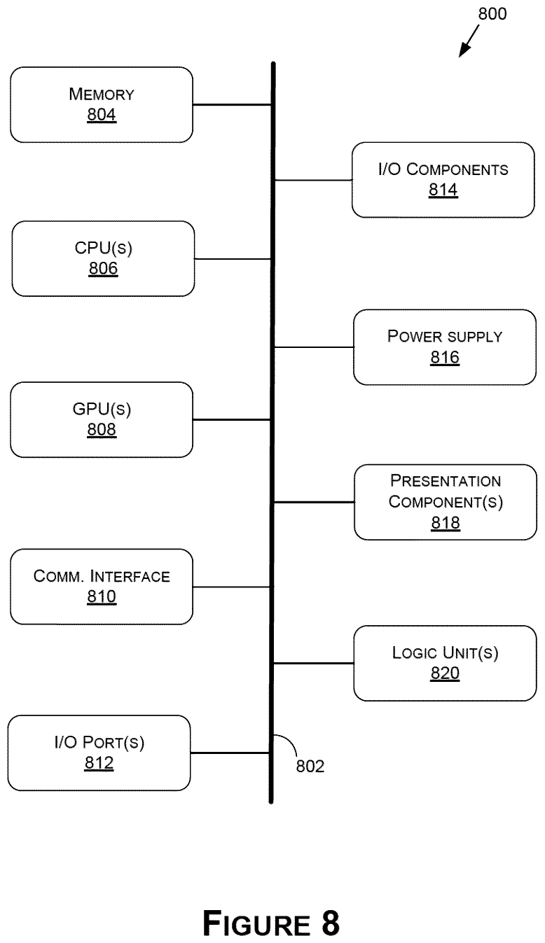

The environment 100 includes an imaging device 102, a query generator 104, a first vision language model system 106A and a second vision language model system 106B (referred to individually as vision language model system 106 and collectively as vision language model systems 106, where contextually appropriate), and a computing device 108. In some embodiments, the imaging device 102, the query generator 104, the vision language model systems 106, and the computing device 108 can include one or more components that are the same, or similar to, one or more components of the computing device 800 of FIG. 8. In some embodiments, one or more devices of the FIG. 1 can interconnect using one or more wired and/or wireless connections, such interconnections corresponding to one or more networks as described herein.

In some embodiments, the imaging device 102 can include one or more devices configured to be in communication with the computing device 108. For example, the imaging device 102 can include one or more devices configured to be in wired and/or wireless communication with the computing device 108, thereby establishing wired and/or wireless communication connections with the computing device 108. In some embodiments, the imaging device 102 can include a device that is configured to generate and/or obtain image data. For example, the imaging device 102 can include a device that is configured to capture image data associated with real-world data such as two-dimensional (2D) images, three-dimensional (3D) images, and/or the like. In another example, the imaging device 102 can include one or more processors configured to generate image data (e.g., representing a 2D or 3D image). The imaging device 102 can then transmit image data to the computing device 108 using the one or more wired and/or wireless communication connections. In some embodiments, the imaging device 102 can include one or more of: a digital camera, a signal source and receiver, image generation software, and/or the like. In some embodiments, the imaging device 102 may include, but is not limited to, an x-ray device, a computed tomography scanner, an ultrasound machine, a positron emission tomography scanner, a single photon emission computed tomography scanner, an optical coherence tomography scanner, or other imaging systems.

In some embodiments, the query generator 104 can include one or more devices configured as components within the computing device 108. For example, the query generator 104 can include one or more devices configured to be in wired and/or wireless communication with the computing device 108, thereby establishing the vision language model system 106A as a component of the computing device 108. In some embodiments, the query generator 104 can include a device that is configured to output one or more queries based at least on the image data. For example, the query generator can include a device that generates a string of text based at least on the image data. The query generator 104 can then transmit the string of text to the vision language model system 106 to prompt it to generate data on a degree of quality associated with the image data. In some embodiments, the query generator can be associated with (e.g., implement) a large language model and/or database that is used to generate the queries as described herein.

In some embodiments, the vision language model system 106 can include the vision language model system 106A and/or 106B. The vision language model system 106A can include one or more devices configured as components within the computing device 108. For example, the vision language model system 106A can include one or more devices configured to be in wired and/or wireless communication with the computing device 108, thereby establishing the vision language model system 106A as a component of the computing device 108. Additionally, or alternatively, the vision language model system 106 can include the vision language model system 106B. In some embodiments, the vision language model system 106B can include one or more devices configured to be in communication with the computing device 108. For example, the vision language model system 106B can include one or more devices configured to be in wired and/or wireless communication with the computing device 108, thereby establishing wired and/or wireless communication connections with the computing device 108.

In some embodiments, the vision language model systems 106 can include one or more devices configured to generate an output in response to the query. In some examples, the vision language model system 106 can include one or more artificial intelligence and/or machine learning-based models. For example, the vision language model system 106 can include a first model configured to analyze image data and a second model that generates a text output. In this example, the second model can generate output based at least on the output of the first model.

In some embodiments, the computing device 108 can include one or more devices configured to be in communication with the imaging device 102, the query generator 104, and/or the vision language model system 106. For example, the computing device 108 can include one or more devices configured to be in wired and/or wireless communication with the imaging device 102, the query generator 104, and/or the vision language model system 106, thereby establishing wired and/or wireless communication connections with the computing device 108. In some embodiments, the computing device 108 can include a device that is configured to generate a quality assessment of the image data. In some examples, the computing device 108 can include the query generator 104, configured to generate a query base at least on the image data. In this example, the computing device 108 can provide the query to the vision language model system 106 to cause it to generate an output. The computing device 108 can then assess degree of quality associated with the image data based at least on the output of the vision language model system 106.

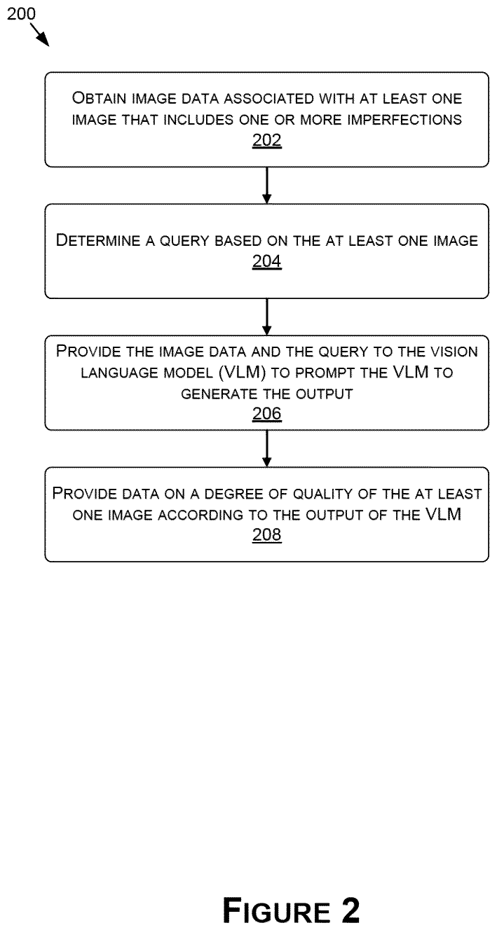

Now referring to FIG. 2, illustrated is a flow diagram of an example method 200 for evaluating image data for one or more imperfections using a VLM, in accordance with some embodiments of the present disclosure. Each block of the method 200, described herein, comprises a computing process that can be performed using any combination of hardware, firmware, and/or software. For instance, various functions can be carried out by a processor executing instructions stored in memory. The method 200 can also be embodied as computer-usable instructions stored on computer storage media. The method 200 can be provided by a standalone application, a service or hosted service (standalone or in combination with another hosted service), or a plug-in to another product, to name a few. In addition, the method 200 is described, by way of example, with respect to the environment 100 of FIG. 1. However, this method 200 can additionally or alternatively be executed by any one system, or any combination of systems, including, but not limited to, those described herein.

The method 200, at block 202, includes obtaining image data associated with at least one image. For example, a computing device (e.g., that is the same as, or similar to, the computing device 108 of FIG. 1) can obtain image data associated with at least one image that may or may not include one or more imperfections (e.g. noise, blur, distortion, artifacts, chromatic aberration, vignetting, aliasing, incorrect labels, and/or the like). The computing device can obtain the image data from an imaging device (e.g., that is the same as, or similar to, the imaging device 102 of FIG. 1). In some examples, the image data can be generated by a camera. For example, the computing device can obtain the image data from a camera based at least on (e.g., in response to) the at least one image being captured by the camera. In another example, the computing device can obtain image data representing a video (e.g., a series of images) from the camera. In this example, the series of images can correspond to frames of the video. In other examples, the image data can be computer generated. For example, a computer can generate the at least one image in response to execution of one or more ray tracing operations and/or the like. In yet another example, the computing device can obtain the image data based at least on execution of one or more operations by the computing device when computer generating the at least one image.

In some embodiments, the image data can be associated with a plurality of values that correspond to a plurality of pixels included in the at least one image. For example, the at least one image can be represented as a plurality of pixels. In this example, the plurality of pixels can be arranged in a two-dimensional (2D) array with values corresponding to any given pixel representing one or more of: a color assigned to the pixel, a label assigned to the pixel, etc. In some embodiments, the values corresponding to the one or more pixels (e.g., each pixel) can be associated with one or more channels. In one example, each pixel can be associated with a first channel and a second channel, the first channel corresponding to a first portion of an electromagnetic spectrum, and the second channel corresponding to a second portion of the electromagnetic spectrum that is at least in part different from the first portion of the electromagnetic spectrum. In another example, each pixel can be associated with a channel that corresponds to one or more labels. For example, in the context of image segmentation and object classification, one or more channels can be reserved for labels assigned to each pixel to indicate that the pixel corresponds to a given feature (e.g., object) in the image. In another example, one or more channels can be reserved to indicate that the pixel corresponds to (e.g., is classified as representing) a type of feature (e.g., a portion of a medical instrument such as a grasper, an anatomical feature such as an organ or other types of tissue, etc.). While the present disclosure is described in the context of 2D arrays, it will be understood that other multi-dimensional arrays (e.g., three-dimensional (3D) arrays etc.) are also contemplated.

In some embodiments, the imperfections in the at least one images obtained by the computing device can result in some features represented by the image being difficult and/or impossible for a viewer or downstream system to distinguish. In an example, the image data can include at least one image that that is generated by a camera (e.g., a camera capturing images in the real-world, a camera used to generate computer-generated images, and/or the like). In this example, the imperfections can include blurry features, etc., that are attributed to the conditions in which the images were captured, generated, and/or the like. In another example, the image data can include at least one image that is labeled (e.g., tagged) to indicate segmentations and/or classifications of one or more features in the at least one image. In this example, the imperfections can include tags that are incorrectly assigned to one or more pixels (e.g., do not match the actual objects represented by the image). This can result in downstream systems performing one or more operations based at least on incorrect indications of the type of the feature(s) in the images.

In some embodiments, the computing device can determine a context for the at least one image. For example, the computing device can determine a context for the at least one image based at least on a feature of the at least one image. As one example, the computing device can determine a context including a description of the feature(s) represented by the at least one image. Where the feature indicates an object in the image, the context can include a label for the object. In some embodiments, the computing device can implement a segmentation model and/or a classification model to determine the context. For example, the computing device can provide the image data to the segmentation model to cause the segmentation model and/or a classification model to generate an output indicative of the context. The segmentation model can include a neural network and/or the like that is configured to receive the image data as an input and generate an output representing the partitioning of the features in the at least one image and/or the type(s) of the features. The computing device can then determine the context based at least on partitioning and/or classifying the features within the at least one image. In some examples, the computing device can use the output of the classification model to assign labels to one or more pixels of the at least one image to indicate a type of object represented by that pixel in the at least one image.

In some embodiments, the computing device can determine the context based at least on a context established by a different image(s). For example, the different image can be captured by the imaging device at a point in time prior to the at least one image being analyzed in a sequence of images. In an example where the image data includes frames of a video, the different image can be an image associated with a prior frame of the video. In this example, the computing device can determine features associated with the context of the image based at least on features present in the previous image and/or frame of the video. As an example, in instances where the image data represents images captured during a medical procedure, the computing device can determine a context (e.g., that objects associated with the medical procedure such as graspers, end effectors, etc., are represented throughout at least portions of the medical procedure) based at least on one or more features of the at least one image being classified as a medical device (or a portion thereof), an anatomical structure (or a portion thereof), etc. Additionally, or alternatively, when the computing device is associated with a predetermined context (e.g., where the computing device is configured for use in a surgical theater), the computing device can determine the context for the at least one image based at least on the predetermined context.

The method 200, at block 204, includes determining a query based at least on the at least one image. For example, the computing device can determine the query to configure (e.g., prompt) a VLM to generate an output indicative of one or more imperfections of the at least one image. In some examples, the query can be configured to prompt the VLM about a feature associated with the context. For example, the query can be selected to configure the VLM to determine whether there are any imperfections associated with the feature. In these examples, the query can prompt the VLM to provide an output describing specific issues with the image, such as a particular feature being burry or one or more labels corresponding to the feature being incorrect. In other examples, the query can prompt the VLM to generate responses to more general questions about the image. For example, the query can prompt the VLM to determine whether the image is clean, grainy, is associated with appropriate lighting, etc.

In some embodiments, the computing device can determine a set of one or more strings associated with the context to use when generating a query. For example, the computing device can determine a set of strings, where one or more (e.g., each) string in the set of strings is associated with a possible feature of the at least one image. In this example, the possible feature can include a feature that is expected to be represented in the image based at least on the context. In examples where the features represented by the at least one image include objects, the strings can include labels indicative of a type of the objects that can be present in the at least one image based at least on the context. The computing device can then determine the query based at least on the set of strings. For example, the computing device can determine the query such that the query includes the set of strings to prompt the VLM to generate an output in accordance with the set of strings. In this example, the set of strings can cause the VLM to generate an output indicative of the quality of the feature as represented by the at least one image, etc.

In some embodiments, the computing device can identify annotations made to the at least one image. For example, annotations can be assigned to the at least one image (e.g., the entire image, one or more pixels of the image, etc.) by associating a string in the set of strings, a value (e.g., a numerical value), etc., with a portion of (e.g., at least one pixel of) the at least one image. The strings or values can be used to label pixels that are associated with one or more features present on the image. In some examples, the annotations can be applied (e.g., by the computing device or by another device that is involved in generating the one or more images) to the pixels of the at least one image using a second channel (e.g., a channel that does not represent the color of the pixels). In this example, a color associated with each pixel in the plurality of pixels can be associated with a first channel corresponding to pixel values representing the image and strings or values corresponding to a second channel can represent the annotations. A visual display of the image can be based at least on a combination of the first and second channels.

In some embodiments, the computing device can determine the query based at least on the annotations assigned to the pixel(s) of the at least one image. For example, the computing device can determine the query such that the query is configured to prompt the VLM to indicate mismatches between annotations and a context for the at least one image. In this example, the query can cause the VLM to indicate that an annotation is in an unusual location relative to another annotation on the image (e.g., that a pixel is annotated as “tissue” despite the pixels immediately surrounding the pixel being annotated as “medical device”). In another example, the query can be configured to cause the VLM to determine whether there are one or more mismatches between annotations in the at least one image and a previous image. For example, the query can cause the VLM to determine whether there are annotations that identify similar features in similar locations from image to image in a set of images. In the above described examples, the queries can cause the VLM to determine annotation errors that can be based at least on the segmentation and/or classification of the objects represented by the at least one image. For example, the queries can cause the VLM to determine that the annotations of the at least one image correctly or incorrectly identify a feature represented by the at least one image. This can allow the computing device to determine whether the annotations assigned to portions of the at least one image are consistent.

In some embodiments, the computing device can determine the query from among a plurality of queries. For example, one or more of the queries can be configured to cause the VLM to indicate an imperfection from among a plurality of possible imperfections as described above. The computing device can then determine (e.g., select) the query from among the plurality of queries described to cause the VLM to provide outputs responsive to the query when analyzing the at least one image for imperfections.

The method 200, at block 206, includes providing the image data and the query to the VLM to cause (e.g. prompt) the VLM to generate an output. For example, the computing device can provide the image data and the query to the VLM as an input to cause the VLM to generate an output. The output can include a string of text indicating one or more imperfections that affect the at least one image. In some examples, the VLM can include a machine learning-based system (e.g., a model) implemented by the computing device. In other examples, the VLM can be an external model (e.g., a model hosted by another device that is the same as, or similar to, the vision language model system 106B of FIG. 1). For example, the computing device can provide the image data and the query to the VLM when implemented by a separate device (e.g., the VLM system 106B) and receive the output using a communication network.

In some embodiments, VLM can include a machine learning-based system designed to process and integrate image data and queries (e.g., text-based queries, etc.) simultaneously. In some embodiments, a VLM can be configured to receive the image data and the query as an input and process the input using an image encoder, a text encoder, and a fusion system. The image encoder can include a neural network that is configured to receive the image data and generate an image embedding vector (e.g., an image embedding) in response to extracting features from the at least one image. Similarly, the text encoder can include a neural network that is configured to receive the query and generate a text embedding vector (e.g., a text embedding) in response to extracting features from the query. The fusion system can include a neural network that is configured to perform one or more cross-attention operations based at least on the image embedding and the text embedding, and attribute weights to the features represented by both to focus on relevant features in the at least one image. The fusion system can then merge the extracted and weighted features into a unified format, and decode the unified format to generate the output responsive to the query that is indicative of the imperfection(s) represented by the at least one image and responsive to the query.

In some embodiments, to provide the image data and the query to the VLM, the computing device can provide a portion of the image data associated with the first channel and/or the second channel of the at least one image to the VLM. The VLM can then generate the output based at least on the provided portion of the image data. In one example, where the image is associated with three channels associated that correspond to different regions of the electromagnetic spectrum, the computing device can cause the VLM can generate the output based at least on the channel associated with the red/green/blue regions of the electromagnetic spectrum. In another example, where the second channel includes annotations, the computing device can cause the VLM to generate the output based at least on the colors represented by the pixels of the at least one image and the annotations corresponding to the pixels. In these examples, the query can be configured to cause the VLM to analyze the values associated with each channel, or to evaluate aspects of each channel for imperfections separately from one another.

In some embodiments, the output of the VLM can include a first output that indicates one or more first imperfections. For example, the computing device can determine, based at least on the first output, that the one or more images include one or more first imperfections. In this example, the first output can indicate an imperfection that is represented across a larger portion (e.g., some and/or all) of the at least one image, such as blurriness or incorrect annotation of one or more pixels of the at least one image. The computing device can then determine a second query based at least on the one or more first imperfections. For example, the computing device can determine the second query such that the second query is configured to prompt the VLM to indicate that one or more second imperfections are or are not present in the at least one image. The second imperfections can correspond to a relatively smaller or more specific portion of the at least one image, such as an imperfection related to a particular feature (e.g., that a particular object is blurry, that a particular pixel or set of pixels are incorrectly annotated, etc.). Alternatively, the second imperfection can be a different type of imperfection. For example, the first imperfection can indicate that objects are blurry in the at least one image, and the second imperfection can indicate that a specific object is blurry, is associated with a darker lighting condition (e.g., in a shadow) when compared to other objects visible to the camera, incorrect labels, etc. In examples, the computing device can provide the image data and the second query to the VLM to cause the VLM to generate a second output. In some examples, the second output can indicate that the at least one image includes the one or more second imperfections.

The method 200, at block 208, includes providing data on a degree of quality of the at least one image associated with the one or more imperfections. For example, the computing device can determine a degree of quality based at least on the outputs of the VLM described herein. The computing device can then provide the data on the degree of quality of the at least one image to indicate that the one or more imperfections exist or do not exist in the at least one image. Additionally, or alternatively, the computing device can provide the data on the degree of quality, where the degree is represented as a value (e.g., a percentage) indicating an amount of the at least one image that is affected by the one or more imperfections. This data can be provided as an output (e.g., on a display device controlled by the computing device) or to a different computing device.

In some examples, the degree of quality can be based at least on the output of the VLM. For example, the computing device can determine a numerical score (e.g., a value between 0 and 1) based at least on the quality of the at least one image indicated by the output of the VLM. In this example, the computing device can provide a degree of quality that indicates an amount of the at least one image affected by the imperfections present in the image, etc. In some examples, the degree of quality of the at least one image can indicate whether the one or more imperfections satisfy a threshold indicating whether one or more imperfections are substantial. For example, where the threshold represents a degree to which an imperfection affects an overall area of an image (e.g., that 20% of the image is subject to blur, 40% of the image is subject to blur, etc.) the computing device can compare the output of the VLM to the threshold to determine whether the threshold is satisfied. In one example, where the output of the VLM indicates that 60% of the image is subject to blur, the computing device can determine that a threshold (e.g., 40% blur) is satisfied and that the at least one image includes the imperfections (blur). In another example, the output of the VLM can indicate that only a small portion (e.g., 5 to 10%) of the image is subject to blur, and the computing device can determine that the threshold is not satisfied. In this example, the computing device can generate the data on the degree of quality of the at least one image associated with the one or more imperfections to either include a binary indication (e.g., that blur represented in the at least one image does or does not affect enough of the at least one image to satisfy the threshold), or a numerical indication of an amount of blur (e.g., 5%, 10%, 40%, 60%, etc.).

In some examples, the computing device can determine that the one or more imperfections satisfy the threshold in response to determining that the one or more imperfections impede practical use of the image. As an example, an image can satisfy the threshold based at least on the computing device determining that the objects in the image are blurry to a point where a system configured to obtain data associated with the image and classify features (e.g. objects) that are present in the image will not be able to classify such objects with a predetermined degree of accuracy. Alternatively, the computing device can determine that the one or more imperfections do not satisfy the threshold (e.g. the imperfections are not severe enough) in response to determining that they do not impede practical use of the image. Again, an image may not satisfy the threshold based at least on the computing device determining that the objects in the image are not blurry to a point where a system configured to obtain data associated with the image and classify features (e.g. objects) that are present in the image will not be able to classify such objects with a predetermined degree of certainty.

In some embodiments, the computing device can determine the degree of quality associated with the at least one image according to the second output of the VLM. For example, the computing device can cause the VLM to generate a first output and a second output as described herein, where the first output indicates that an imperfection exists (e.g., that the image is at least in part affected by blur) and the second output indicates specific aspects of that imperfection.

In some embodiments, the computing device can generate the data on the degree of quality of the at least one image associated with the one or more imperfections. For example, the computing device can generate the data on the degree of quality to include data associated with a graphical user interface (GUI). The GUI can include a representation of the degree of quality determined by the computing device and be configured to cause a display device to display the representation of the degree of quality. For example, the GUI can include a representation of the at least one image identified as including one or more imperfections, along with an indication of the one or more imperfections. In this example, the GUI can include a highlighted portion to indicate the one or more imperfections, a string of text that indicates the one or more imperfections, etc.

In some embodiments, the computing device can cause one or more operations to be performed based at least on the degree of quality of the at least one image. For example, where the at least one image are identified as having a degree of quality that is not appropriate for model training, the computing device can cause one or more systems to forgo including the at least one image in a training dataset. This, in turn, can prevent the one or more systems from training and/or updating one or more models using the at least one image having an identified imperfection.

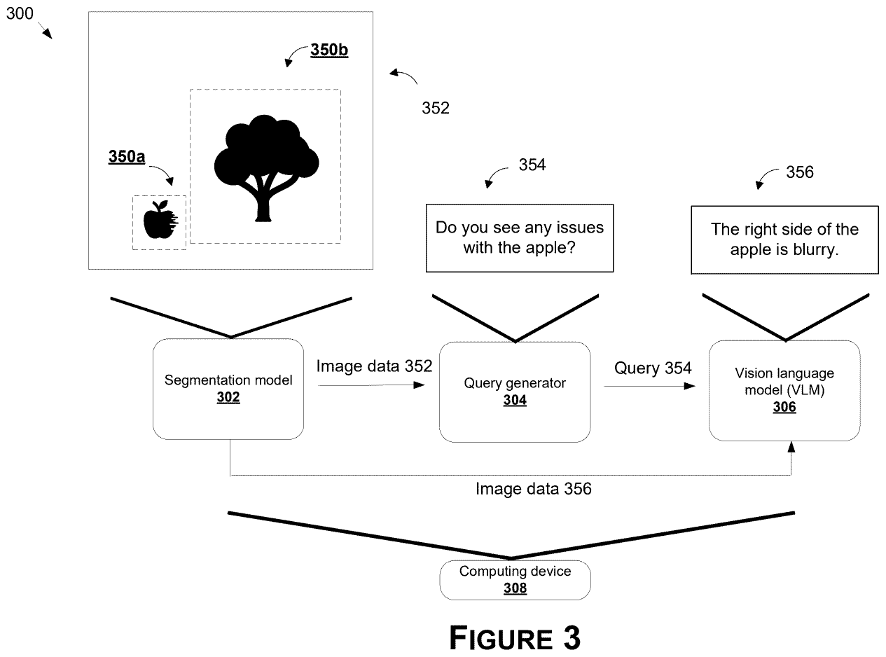

Now referring to FIG. 3, each block of implementation 300, described herein, comprises a computing process that can be performed using any combination of hardware, firmware, and/or software. For instance, various functions can be carried out by a processor executing instructions stored in memory. The implementation 300 can also be embodied as computer-usable instructions stored on computer storage media. The implementation 300 can be executed by a standalone application, a service or hosted service (standalone or in combination with another hosted service), or a plug-in to another product, to name a few. In addition, the implementation 300 is described, by way of example, with respect to the environment 100 of FIG. 1 and/or the method 200 of FIG. 2. However, the implementation 300 can additionally or alternatively be executed by any one system, or any combination of systems, including, but not limited to, those described herein.

Initially, a computing device 308 (e.g., that is the same as, or similar to, the computing device 108 of FIG. 1) can segment image data 352 associated with one or more images. For example, the computing device 308 can provide the image data 352 to the segmentation model 302 to be segmented into multiple regions according to distinct features represented in the at least one image. The segmentation model 302 can include a model as described herein that is trained and/or updated on a set of image data (including images and corresponding labels indicating the features in the image on a pixel-by-pixel basis) to identify pixels and/or clusters of pixels that represent features within a given image or set of images. In an example, the image data 352 can be segmented to separate the features represented in the at least one image into corresponding regions (e.g., areas within the at least one image). In this example, the computing device 308 can additionally implement a classification model (not explicitly illustrated) to determine labels 350 for the pixels corresponding to the features of the at least one image. The labels 350 can include strings, values, and/or the like indicative of a type of the feature. As shown in FIG. 3, the image data 352 can be segmented to identify an apple 350a and a tree 350b. In some examples, the computing device 308 can then generate the labels 350 including strings of text including “apple” and “tree” (or values corresponding to the term “apple” and “tree” respectively) and annotate the image data 352 with the string(s) or value(s) on a per-image basis, a per-pixel basis, etc.

In some embodiments, a query generator 304 can be configured to determine (e.g., generate, etc.) a query based at least on the output of the segmentation model 302 and/or the classification model. For example, the query generator 304 can determine the query 354 based at least on the labels 350 assigned to the at least one image. In some embodiments, the query generator 304 can incorporate at least one of the labels 350 into the query 354. For example, the query generator 304 can generate the query to prompt a VLM system 306 to determine if there are any features represented in the at least one image based at least on the labels 350, issues with a feature identified by one of the labels (e.g. “Do you see any issues with the apple?”), etc. In some examples, the query generator 304 can include a language model (e.g., large language model) as described herein that generates the query 354 based at least on the labels associated with the image data 352. In another embodiment, the query generator 304 can include a dataset of predetermined queries. Additionally, or alternatively, the query generator 304 can determine the query 354 based at least on a context associated with the image data 352. For example, the query generator 304 can determine that an apple 350a and a tree 350b are represented in the at least one image. The query generator 304 can then determine the context (e.g., that the at least one image represents vegetation, is captured in an outdoors setting, may have other objects related to apples and trees represented therein, etc.) in accordance with the presence of the apple 350a and the tree 350b, and generate the query based at least on the context.

As noted above, the query generator 304 can be associated with (e.g., include) a dataset of queries. For example, the query generator 304 can include a dataset of queries including past queries generated by the query generator 304, a predetermined set of queries that are configured to cause the VLM 306 to scan for specific imperfections, and/or the like. In some embodiments, the query generator 304 can determine the query 354 for the at least one image being analyzed based at least on identifying the query 354 in the data set of queries that is compatible with a context of the at least one image being analyzed. For example, the query generator 304 can determine the query 354, where it includes a generic query (e.g. “Are there any issues with the image?”). Additionally, or alternatively, the query generator 304 can include a dataset of query templates. In these examples, the query generator 304 can determine the query 354 based at least on identifying a query template (e.g. “Do you see any issues with the ______?”) that is compatible with the context of the at least one image being analyzed and inserting at least one of the labels into the blank (e.g. “Do you see any issues with the apple?”). Additional examples of queries can include: “Is the video completely black?”, “Can you tell the color of sky in the video?”, “Do you see any issues with the motion of car?”, “Is the image clean?”

In some embodiments, the VLM 306 can be configured to obtain the image data 352 associated with the at least one image being analyzed and the query 354 and, in response, generate an output 356. For example, the VLM 306 can include a neural network as described herein that is configured to analyze the image data and the query together, and generate a text output responsive to the query. In some examples, the VLM 306 can additionally receive the labels 350 assigned to the at least one image. In these examples, the VLM 306 can generate an output 356 based at least on the image data 352, labels 350, and/or query 354. As shown, the output 356 can include a text string describing an imperfection in the image (e.g. “The right side of the apple is blurry.”). In examples, the output can describe a degree of imperfection, describe multiple imperfections, indicate that no imperfections were identified, etc.

In some embodiments, the computing device 308 can provide data on a degree of quality of the image data based at least on the output 356 of the VLM 306. The computing device 308 can also provide an assessment of the degree of quality (e.g. “good” or “bad”, a numerical score, and/or the like) as at least part of the data on a degree of quality. For example, as illustrated in FIG. 3, the computing device 308 can determine that the image data is of “bad” quality based at least on the output 356 describing that “The right side of the apple is blurry.” In this example, the computing device 308 can determine that the image data is of “bad” quality based at least on the imperfection (e.g. part of an object identified as blurry) described in the output 356. In some embodiments, the data on the degree of quality provided by the computing device 308 can additionally, or alternatively, include the output 356. For example, the computing device 308 can provide the entire text string comprising the output 356. In one example, the computing device 308 can generate the data on the degree of quality to include an indication of which feature(s) represented by the at least one image includes imperfections (e.g. the apple), a location of the imperfection relative to the feature (e.g. the right side), and/or what the imperfection is (e.g. blur) based at least on the output 356 of the VLM 306.

In some embodiments, the computing device 308 can generate the data on a degree of quality based at least on multiple outputs of the VLM system 306. In an example, the query generator 304 can generate a second query based at least on the output 356 (described above). The computing device 308 can then use the output of the query generator 304 to prompt the VLM 306 to answer a question about the output. In some examples, the VLM 306 can again be prompted by the computing device 308 to generate a second output based at least on the image data and the second query. For example, the query generator 304 can generate a query “How blurry is the right side of the apple?” based at least on the output 356. In this example, the VLM 306 can generate a second output, “The right side of the apple is mildly blurry” in response to the second query.

In some examples, the computing device 308 can generate data on the degree of quality on at least one of the first and second outputs. For example, as described above, the computing device 308 can determine the degree of quality is “good” based at least on the second output. In this example, the degree of quality (e.g. “good”) can be determined based at least on the imperfection being described as mild. The query generator 304 can then generate the second query based at least on the computing device 308 requesting more information on the quality of image data. For example, the query generator 304 can continue to generate queries based at least on an output of the VLM 306 until the computing device 308 determines it has received sufficient output to provide data on a degree of quality. Alternatively, the query generator 304 can be programmed to repeat the process a set number of times. For example, the query generator 304 can be programmed to repeat the process three times and the computing device 308 can generate the data on the degree of quality based at least on receiving three outputs from the VLM 306.

In some embodiments, the segmentation model 302, query generator 304, and VLM system 306 can be part of (e.g., implemented by) the computing device 308. For example, the segmentation model 302 can generate and provide the output described above to the query generator 304. Similarly, the query generator 304 can generate and provide the output described above to the VLM 306. In another example, the VLM 306 can be implemented by a different computing device (not explicitly illustrated). For example, the computing device 308 can transmit the query to a different computing device that is implementing one or more of the segmentation model 302, the query generator 304, and/or the VLM 306 and obtain the outputs from the different computing device.

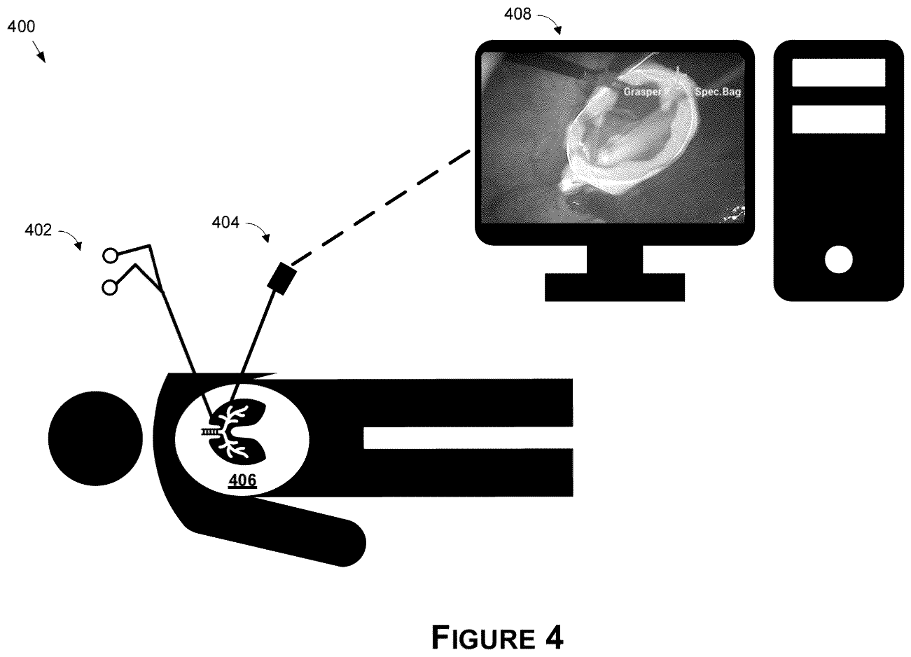

Now referring to FIG. 4, FIG. 4 is an example scene 400 of a real-world application involving evaluation of image data for one or more imperfections, in accordance with some embodiments of the present disclosure. As illustrated in the scene 400, a surgery (e.g. laparoscopic surgery) can performed using a surgical tool 402 (e.g. an endoscopic instrument including a grasper, scissors, etc.) and a camera 404 (e.g. an endoscope). In the scene 400, a clinician can perform the surgery using small incisions made for the surgical tool 402 and the camera 404. In this example, the camera 404 can transmit video of the surgical field 406 to a computing device 408, which can display and/or process the images generated by the camera 404 (e.g., a video of the surgery).

The images generated by the camera 404 can then be included in a training dataset and used by a computing device (e.g., the computing device 408 and/or a different computing device not explicitly illustrated in FIG. 4) to train and/or update one or more models. For example, to train and/or update a model to classify objects represented in images of surgical procedures, the images captured by the camera 404 can be annotated (e.g., labeled) such that the features (e.g., objects) represented in the images are identified by their type. By virtue of the implementation of the techniques described herein, one or more computing devices involved in the training and/or updating of the models can first identify images within the training dataset that have one or more imperfections and either update (e.g., repair) the images or remove the images from the training dataset. For example, the computing device 408 may generate a prompt based at least on the image data and provide it to a VLM as described herein to cause the VLM to generate an output indicating whether the at least one image is affected by one or more imperfections. This can allow for the computing devices involved in training and/or updating the model to reduce computing resources that would be otherwise expended training and/or updating the models on the images including the imperfections. Additionally, the resulting accuracy of the model being trained and/or updated can be improved by not being trained and/or updated on images including imperfections that can introduce error into the model's subsequently-generated outputs.

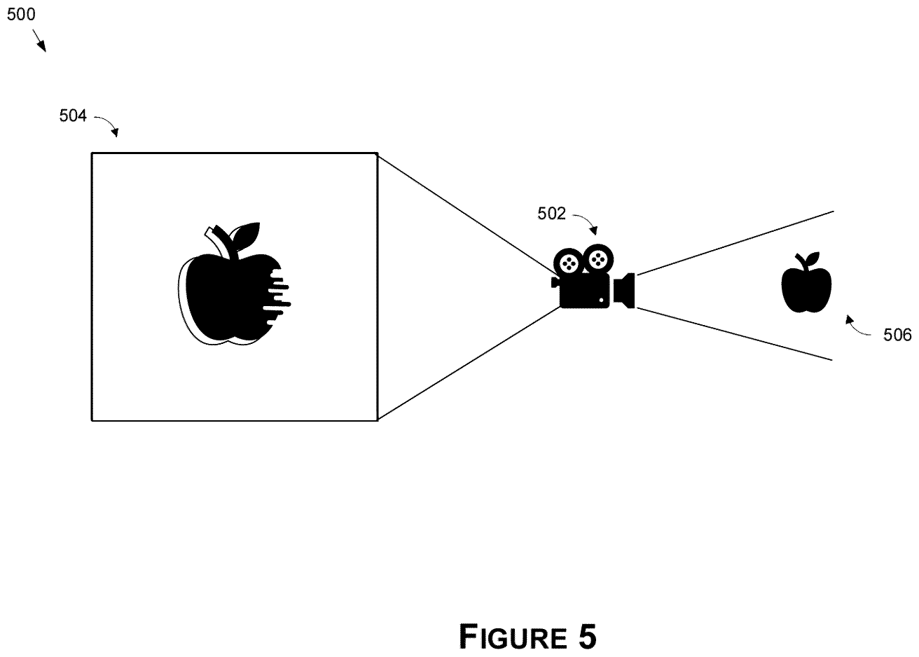

Now referring to FIG. 5, FIG. 5 is an example scene of an imaging device producing image data that includes one or more imperfections, in accordance with some embodiments of the present disclosure. The scene 500 can include an object 506, an imaging device 502, and image data 504. in some examples, the imaging device 502 can capture image data 504 containing an object 506. In an example, the imaging device 502 can be a camera (e.g. digital camera and/or the like). In this example, the image data 504 can be a photo representing the object 506 (e.g. apple). For example, the photo can be 2D matrix of pixels representing visual light reflected from the object 506. In examples wherein the photo is black and white, each pixel can be associated with one value. In other examples wherein the photo is color, each pixel can be associated with three values (e.g. channels) representing the red, green, and blue spectrums of visual light. In some examples, the photo can represent non-visual waves (e.g. infrared, ultraviolet, X-ray, and/or the like) reflected from the object 506. In other examples, the imaging device 502 can be one or more processors configured to generate image data 504. For examples, the imaging device 502 can be configured to create imaging data comprising a simulation of the object 506. In some examples, imaging data can include a single photo. In other examples, imaging data can include video made up of one or more frames (e.g. photos).

In some embodiments, the image data 504 can exhibit one or more imperfections (e.g. noise, blur, distortion, artifacts, chromatic aberration, vignetting, and/or aliasing). As shown in FIG. 5, the right side of the apple is blurry. In some examples, the image data can display multiple types of imperfections. The image data 504 also shows chromatic aberration towards on the left side of the apple. In the described embodiments, the imperfections result in image data 504 that does not accurately depict the object 506.

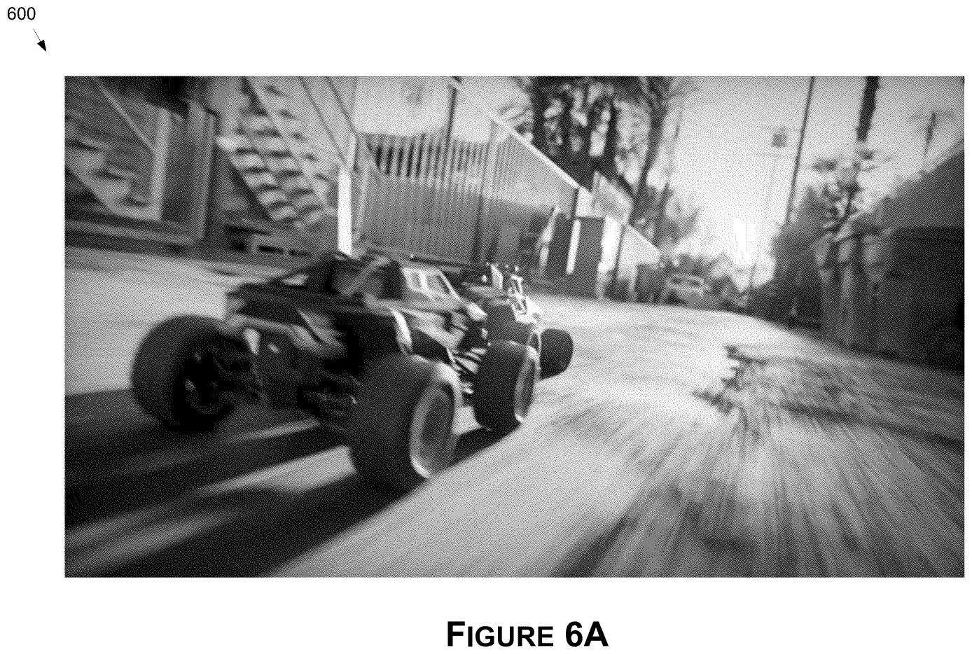

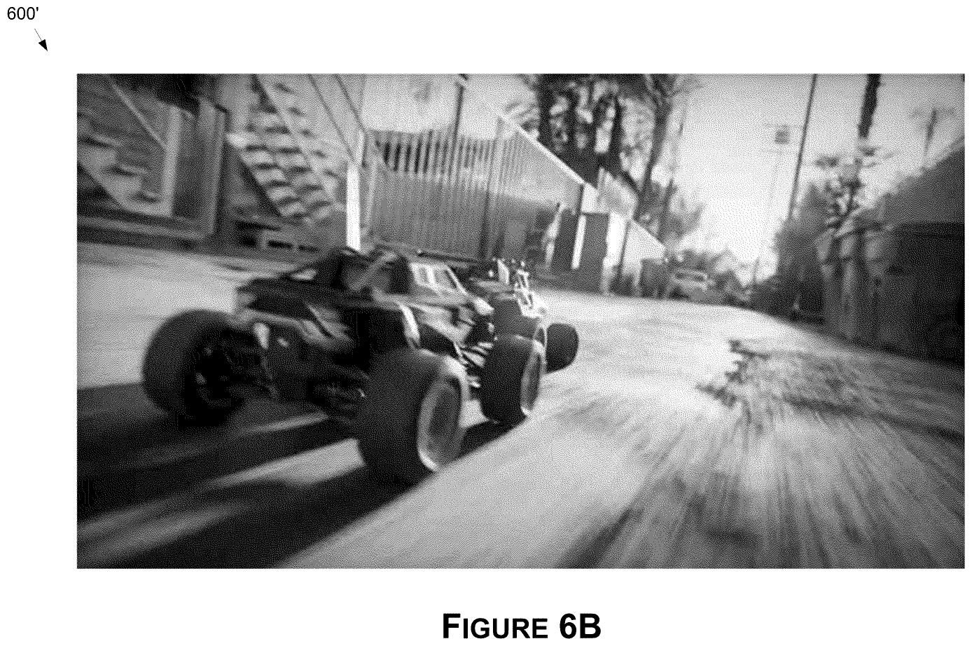

Now referring to FIGS. 6A and 6B, FIG. 6A is an example of a computer-generated image 600 that does not one or more imperfections, and FIG. 6B is an example of a computer-generated image 600′that includes one or more imperfection, in accordance with some embodiments of the present disclosure. For example, the computer-generated image 600 can be generated by a computing device (e.g., that is the same as, or similar to, the computing device 108 of FIG. 1). In some embodiments, the computer-generated image 600 can be compressed using one or more compression techniques (e.g., JPEG, MPEG, etc.). Compression can be performed to reduce the file size of the computer-generated image 600. As can be seen in the computer-generated image 600′, compression can result in blur around the main object (e.g., the toy truck). However, it can also be seen that the computer-generated image 600′ is still coherent (e.g. it can still be recognized as a toy truck). In some examples, the computing device described herein can determine that that the degree of quality of the computer-generated image 600′ shown in FIG. 6B is acceptable based at least on the fact that the image is coherent.

In some examples, the machine learning model(s) (e.g., deep neural networks, language models, LLMs, SLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible using one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's Tensor®), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Language Models

In at least some embodiments, language models, such as large language models (LLMs) and/or other types of generative artificial intelligence (AI), can be implemented. For example, LLMs can be implemented to obtain scene These models can be capable of understanding, summarizing, translating, and/or otherwise generating text (e.g., natural language text, code, etc.), images, video, computer aided design (CAD) assets, omniverse and/or metaverse file information (e.g., in USD format), and/or the like, based at least on the context provided in input prompts or queries. These language models can be considered “large,” in embodiments, based at least on the models being trained on massive datasets and having architectures with large number of learnable network parameters (weights and biases)—such as millions or billions of parameters. The LLMs/SLMs/VLMs/etc. can be implemented for summarizing textual data, analyzing and extracting insights from data (e.g., textual, image, video, etc.), and generating new text/image/video/etc. in user-specified styles, tones, and/or formats. The LLMs of the present disclosure can be used exclusively for text processing, in embodiments, whereas in other embodiments, multimodal LLMs can be implemented to accept, understand, and/or generate text along with other types of content like images, audio, and/or video. For example, vision language models (VLMs), or more generally multimodal language models, can be implemented to accept image, video, audio, textual, 3D design (e.g., CAD), and/or other inputs data types and/or to generate or output image, video, audio, textual, 3D design, and/or other output data types.

Various types of LLM/SLMs/VLM/etc. architectures can be implemented in various embodiments. For example, different architectures can be implemented that use different techniques for understanding and generating outputs—such as text, audio, video, image, etc. In some embodiments, LLM architectures such as recurrent neural networks (RNNs) or long short-term memory networks (LSTMs) can be used, while in other embodiments transformer architectures—such as those that rely on self-attention mechanisms—can be used to understand and recognize relationships between words or tokens. One or more generative processing pipelines that include LLMs can also include one or more diffusion block(s) (e.g., denoisers). The language models of the present disclosure can include encoder and/or decoder block(s). For example, discriminative or encoder-only LLMs like BERT (Bidirectional Encoder Representations from Transformers) can be implemented for tasks that involve language comprehension such as classification, sentiment analysis, question answering, and named entity recognition. As another example, generative or decoder-only LLMs like GPT (Generative Pretrained Transformer) can be implemented for tasks that involve language and content generation such as text completion, story generation, and dialogue generation. LLMs that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular embodiment and the task(s) being performed using the model(s).

In various embodiments, the LLMs/SLMs/VLMs/etc. can be trained using unsupervised learning, in which an LLM learns patterns from large amounts of unlabeled text/audio/video/image/etc. data. Due to the extensive training/updating, in embodiments, the models can not require task-specific or domain-specific training/updating. LLMs that have undergone extensive pre-training on vast amounts of unlabeled text data can be referred to as foundation models and can be adept at a variety of tasks like question-answering, summarization, filling in missing information, and translation. Some LLMs can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/etc. of the present disclosure can be implemented using various model alignment techniques. For example, in some embodiments, guardrails can be implemented to identify improper or undesired inputs (e.g., prompts) and/or outputs of the models. In some non-limiting embodiments, the guardrails implemented can be similar to those described in U.S. patent application No. 18,304,341, filed on Apr. 20, 2023, the contents of which are hereby incorporated by reference in their entirety. In some embodiments, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/SLMs/VLMs/etc. of the present disclosure can be less likely to output language/text/audio/etc. that can be offensive, vulgar, improper, unsafe, out of domain, and/or otherwise undesired for the particular application/implementation.

In some embodiments, the LLMs/SLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training/updating, and/or based at least on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., using one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training/updating on a large dataset(s), but also on the expertise or optimized nature of one or more external resources—such as APIs, plug-ins, and/or the like.

In some embodiments, multiple language models (e.g., LLMs/SLMs/VLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data can be provided with the same input query and prompt (e.g., set of constraints, conditioners, etc.). In one or more embodiments, the language models can be different versions of the same foundation model. In one or more embodiments, at least one language model can be instantiated as multiple agents—e.g., more than one prompt can be provided to constrain, direct, or otherwise influence a style, a content, or a character, etc., of the output provided. In one or more example, non-limiting embodiments, the same language model can be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more embodiments, the output from one language model—or version, instance, or agent—can be provided as input to another language model for further processing and/or validation. In one or more embodiments, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more embodiments, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

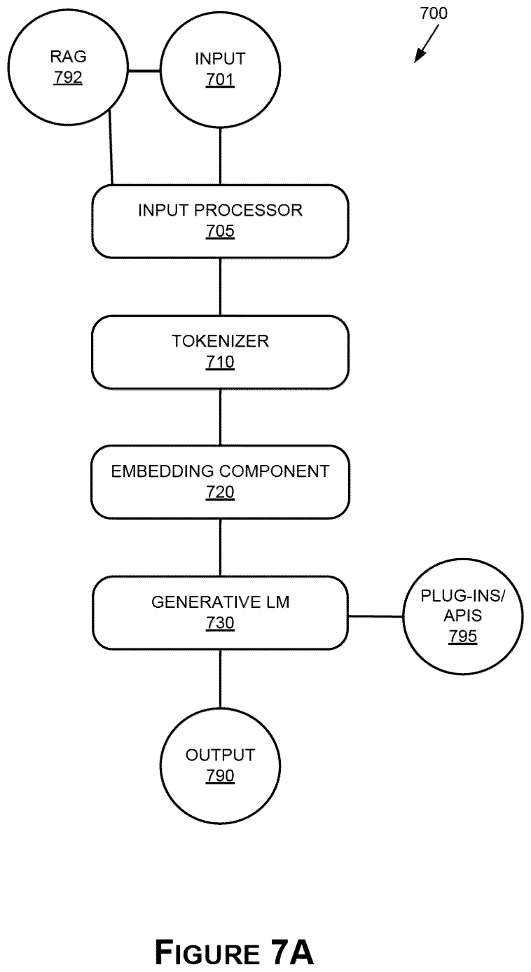

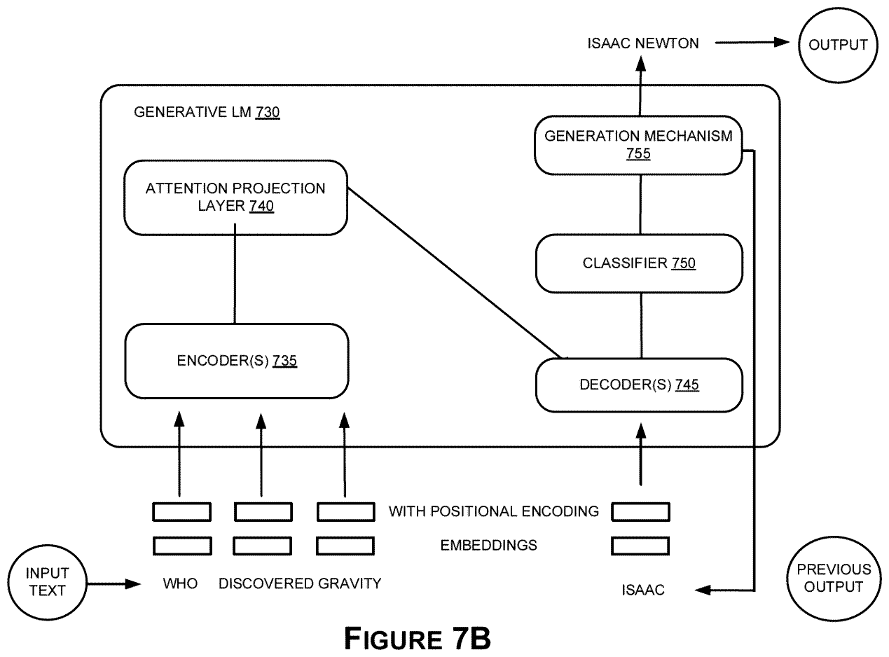

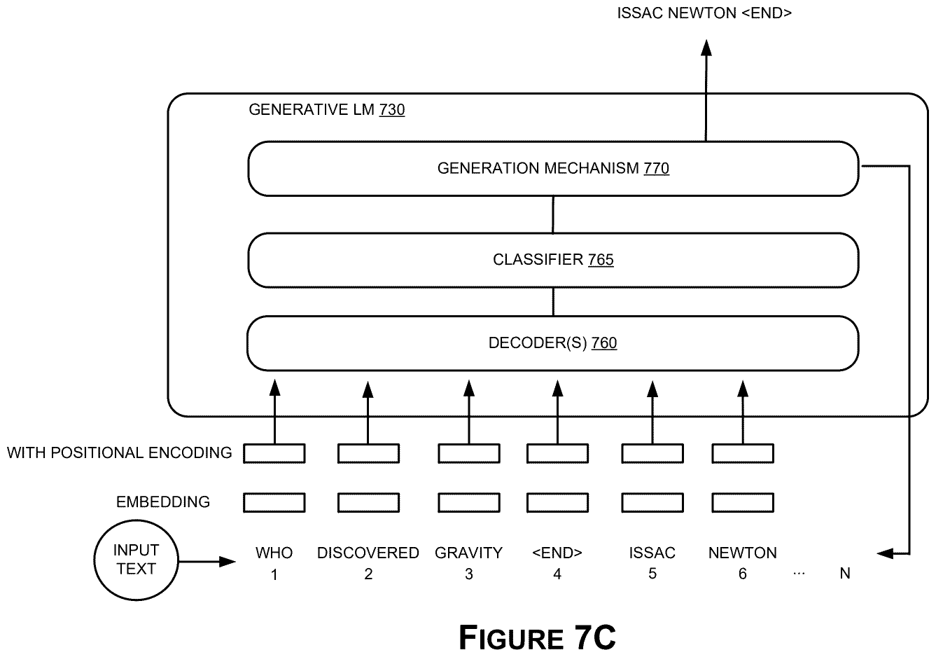

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which can include an LLM, a SLM, a VLM, a multi-modal LM, etc.).

At a high level, the input processor 705 can obtain an input 701 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 730. In some embodiments, the input 701 includes plain text in the form of one or more sentences, paragraphs, and/or documents. Additionally, or alternatively, the input 701 can include numerical sequences, precomputed embeddings (e.g., word or sentence embeddings), and/or structured data (e.g., in tabular formats, JSON, or XML). In some implementations in which the generative LM 730 is capable of processing multimodal inputs, the input 701 can combine text with image data, audio data, and/or other types of input data, such as but not limited to those described herein. Taking raw input text as an example, the input processor 705 can prepare raw input text in various ways. For example, the input processor 705 can perform various types of text filtering to remove noise (e.g., special characters, punctuation, HTML tags, stopwords) from relevant textual content. In an example involving stopwords (common words that tend to carry little semantic meaning), the input processor 705 can remove stopwords to reduce noise and focus the generative LM 730 on more meaningful content. The input processor 705 can apply text normalization, for example, by converting all characters to lowercase, removing accents, and/or or handling special cases like contractions or abbreviations to ensure consistency. These are just a few examples, and other types of input processing can be applied.

In some embodiments, a RAG component 792 can be used to retrieve additional information to be used as part of the input 701 or prompt. For example, in some embodiments, the input 701 can be generated using the query or input to the model (e.g., a question, a request, etc.) in addition to data retrieved using the RAG component 792. In some embodiments, the input processor 705 can analyze the input 701 and communicate with the RAG component 792 (or the RAG component 792 can be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 can retrieve—using a vector search in an embedding space, for example - the tire pressure information or the text corresponding thereto from a digital (embedded) version of the user manual for that particular vehicle make and model. Similarly, where a user revisits a chatbot related to a particular product offering or service, the RAG component 792 can retrieve a prior stored conversation history—or at least a summary thereof—and include the prior conversation history along with the current ask/request as part of the input 701 to the generative LM 730.

The tokenizer 710 can segment the (e.g., processed) text into smaller units (tokens) for subsequent analysis and processing. The tokens can represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy can depend on factors such as the language being processed, the task at hand, and/or characteristics of the training/updating dataset. As such, the tokenizer 710 can convert the (e.g., processed) text into a structured format according to tokenization schema being implemented in the particular embodiment.

The embedding component 720 can use any known embedding technique to transform discrete tokens into (e.g., dense, continuous vector) representations of semantic meaning. For example, the embedding component 720 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data, the input processor 705 can resize the image data to a standard size compatible with format of a corresponding input channel and/or can normalize pixel values to a common range (e.g., 0 to 1) to ensure a consistent representation, and the embedding component 720 can encode the image data using any known technique (e.g., using one or more convolutional neural networks (CNNs) to extract visual features). In some implementations in which the input 701 includes audio data, the input processor 705 can resample an audio file to a consistent sampling rate for uniform processing, and the embedding component 720 can use any known technique to extract and encode audio features—such as in the form of a spectrogram (e.g., a mel-spectrogram). In some implementations in which the input 701 includes video data, the input processor 705 can extract frames or apply resizing to extracted frames, and the embedding component 720 can extract features such as optical flow embeddings or video embeddings and/or can encode temporal information or sequences of frames. In some implementations in which the input 701 includes multimodal data, the embedding component 720 can fuse representations of the different types of data (e.g., text, image, audio) using techniques like early fusion (concatenation), late fusion (sequential processing), attention-based fusion, etc.

The generative LM 730 and/or other components of the generative LLM system 700 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 can apply an encoded representation of the input 701 to the generative LM 730, and the generative LM 730 can process the encoded representation of the input 701 to generate an output 790, which can include responsive text and/or other types of data.

As described herein, in some embodiments, the generative LM 730 can be configured to access or use—or capable of accessing or using—plug-ins/APIs 795 (which can include one or more plug-ins, application programming interfaces (APIs), databases, data stores, repositories, etc.). For example, for certain tasks or operations that the generative LM 730 is not ideally suited for, the model can have instructions (e.g., as a result of training/updating, and/or based at least on instructions in a given prompt, such as those retrieved using the RAG component 792) to access one or more plug-ins/APIs 795 (e.g., 3^{rd} party plugins) for help in processing the current input. In such an example, where at least part of a prompt is related to restaurants or weather, the model can access one or more restaurant or weather plug-ins (e.g., using one or more APIs), send at least a portion of the prompt related to the particular plug-in/API 795 to the plug-in/API 795, the plug-in/API 795 can process the information and return an answer to the generative LM 730, and the generative LM 730 can use the response to generate the output 790. This process can be repeated—e.g., recursively—for any number of iterations and using any number of plug-ins/APIs 795 until an output 790 that addresses each ask/question/request/process/operation/etc. from the input 701 can be generated. As such, the model(s) can not only rely on its own knowledge from training/updating on a large dataset(s) and/or from data retrieved using the RAG component 792, but also on the expertise or optimized nature of one or more external resources—such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 7A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 740 can convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 can generate a first token, and the generation mechanism 755 can apply the generated token as an input during a second pass. The process can repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 can output some decoded (e.g., vector) representation of the input being applied during a particular pass. The classifier 750 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 can select or sample a word or token based at least on a corresponding predicted probability (e.g., select the word with the highest predicted probability) and append it to the output from a previous pass, generating each word or token sequentially. The generation mechanism 755 can repeat the process, triggering successive decoder inputs and corresponding predictions until selecting or sampling a symbol or token that represents the end of the response, at which point, the generation mechanism 755 can output the generated response.

FIG. 7C is a block diagram of an example implementation in which the generative LM 730 includes a decoder-only transformer architecture. For example, the decoder(s) 760 of FIG. 7C can operate similarly as the decoder(s) 745 of FIG. 7B except each of the decoder(s) 760 of FIG. 7C omits the encoder-decoder self-attention layer (since there is no encoder in this implementation). As such, the decoder(s) 760 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 760. As with the decoder(s) 745 of FIG. 7B, each token (e.g., word) can flow through a separate path in the decoder(s) 760, and the decoder(s) 760, a classifier 765, and a generation mechanism 770 can use auto-regression to sequentially generate one token at a time until predicting a symbol or token that represents the end of the response. The classifier 765 and the generation mechanism 770 can operate similarly as the classifier 750 and the generation mechanism 755 of FIG. 7B, with the generation mechanism 770 selecting or sampling each successive output token based at least on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 8 is a block diagram of an example computing device(s) 800 suitable for use in implementing some embodiments of the present disclosure. Computing device 800 can include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 can comprise one or more virtual machines (VMs), and/or any of the components thereof can comprise virtual components (e.g., virtual hardware components). For non-limiting examples, one or more of the GPUs 808 can comprise one or more vGPUs, one or more of the CPUs 806 can comprise one or more vCPUs, and/or one or more of the logic units 820 can comprise one or more virtual logic units. As such, a computing device(s) 800 can include discrete components (e.g., a full GPU dedicated to the computing device 800), virtual components (e.g., a portion of a GPU dedicated to the computing device 800), or a combination thereof. In some embodiments, the computing device 800 (e.g., one or more components of the computing device 800) can be included in one or devices illustrated in FIG. 1 (e.g., the computing device 108 of FIG. 1, etc.).

Although the various blocks of FIG. 8 are shown as connected using the interconnect system 802 with lines, this is not intended to be limiting and is for clarity only. For example, in some embodiments, a presentation component 818, such as a display device, can be considered an I/O component 814 (e.g., if the display is a touch screen). As another example, the CPUs 806 and/or GPUs 808 can include memory (e.g., the memory 804 can be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 can represent one or more links or busses, such as an address bus, a data bus, a control bus, or a combination thereof. The interconnect system 802 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 can be directly connected to the memory 804. Further, the CPU 806 can be directly connected to the GPU 808. Where there is direct, or point-to-point connection between components, the interconnect system 802 can include a PCIe link to carry out the connection. In these examples, a PCI bus need not be included in the computing device 800.

The memory 804 can include any of a variety of computer-readable media. The computer-readable media can be any available media that can be accessed by the computing device 800. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 804 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 806 can be configured to execute at least some of the computer-readable instructions to control one or more components of the computing device 800 to perform one or more of the methods and/or processes described herein. The CPU(s) 806 can each include one or more cores (e.g., one, two, four, eight, twenty-eight, seventy-two, etc.) that are capable of handling a multitude of software threads simultaneously. The CPU(s) 806 can include any type of processor, and can include different types of processors depending on the type of computing device 800 implemented (e.g., processors with fewer cores for mobile devices and processors with more cores for servers). For example, depending on the type of computing device 800, the processor can be an Advanced RISC Machines (ARM) processor implemented using Reduced Instruction Set Computing (RISC) or an x86 processor implemented using Complex Instruction Set Computing (CISC). The computing device 800 can include one or more CPUs 806 in addition to one or more microprocessors or supplementary co-processors, such as math co-processors.

In addition to or alternatively from the CPU(s) 806, the GPU(s) 808 can be configured to execute at least some of the computer-readable instructions to control one or more components of the computing device 800 to perform one or more of the methods and/or processes described herein. One or more of the GPU(s) 808 can be an integrated GPU (e.g., with one or more of the CPU(s) 806 and/or one or more of the GPU(s) 808 can be a discrete GPU. In embodiments, one or more of the GPU(s) 808 can be a coprocessor of one or more of the CPU(s) 806. The GPU(s) 808 can be used by the computing device 800 to render graphics (e.g., 3D graphics) or perform general purpose computations. For example, the GPU(s) 808 can be used for General-Purpose computing on GPUs (GPGPU). The GPU(s) 808 can include hundreds or thousands of cores that are capable of handling hundreds or thousands of software threads simultaneously. The GPU(s) 808 can generate pixel data for output images in response to rendering commands (e.g., rendering commands from the CPU(s) 806 received using a host interface). The GPU(s) 808 can include graphics memory, such as display memory, for storing pixel data or any other suitable data, such as GPGPU data. The display memory can be included as part of the memory 804. The GPU(s) 808 can include two or more GPUs operating in parallel (e.g., using a link). The link can directly connect the GPUs (e.g., using NVLINK) or can connect the GPUs through a switch (e.g., using NVSwitch). When combined together, each GPU 808 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 806 and/or the GPU(s) 808, the logic unit(s) 820 can be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 can discretely or jointly perform any combination of the methods, processes and/or portions thereof. One or more of the logic units 820 can be part of and/or integrated in one or more of the CPU(s) 806 and/or the GPU(s) 808 and/or one or more of the logic units 820 can be discrete components or otherwise external to the CPU(s) 806 and/or the GPU(s) 808. In embodiments, one or more of the logic units 820 can be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 can include one or more receivers, transmitters, and/or transceivers that allow the computing device 800 to communicate with other computing devices using an electronic communication network, included wired and/or wireless communications. The communication interface 810 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 can include one or more data processing units (DPUs) to transmit data received over a network and/or through interconnect system 802 directly to (e.g., a memory of) one or more GPU(s) 808.

The I/O ports 812 can allow the computing device 800 to be logically coupled to other devices including the I/O components 814, the presentation component(s) 818, and/or other components, some of which can be built in to (e.g., integrated in) the computing device 800. Illustrative I/O components 814 include a microphone, mouse, keyboard, joystick, game pad, game controller, satellite dish, scanner, printer, wireless device, etc. The I/O components 814 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 can be include depth cameras, such as stereoscopic camera systems, infrared camera systems, RGB camera systems, touchscreen technology, and combinations of these, for gesture detection and recognition. Additionally, the computing device 800 can include accelerometers or gyroscopes (e.g., as part of an inertia measurement unit (IMU)) that allow detection of motion. In some examples, the output of the accelerometers or gyroscopes can be used by the computing device 800 to render immersive augmented reality or virtual reality.

The power supply 816 can include a hard-wired power supply, a battery power supply, or a combination thereof. The power supply 816 can provide power to the computing device 800 to allow the components of the computing device 800 to operate.

The presentation component(s) 818 can include a display (e.g., a monitor, a touch screen, a television screen, a heads-up-display (HUD), other display types, or a combination thereof), speakers, and/or other presentation components. The presentation component(s) 818 can receive data from other components (e.g., the GPU(s) 808, the CPU(s) 806, DPUs, etc.), and output the data (e.g., as an image, video, sound, etc.).

### Example Data Center

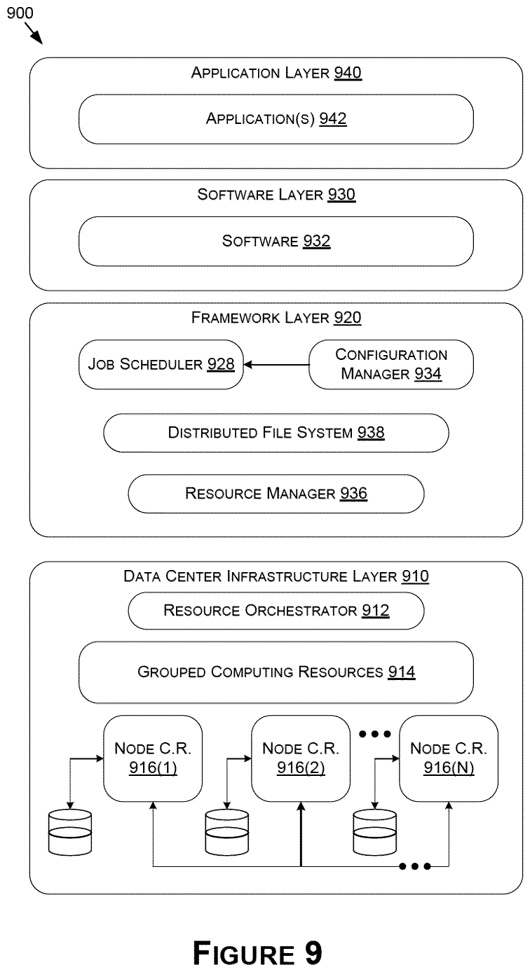

FIG. 9 illustrates an example data center 900 that can be used in at least one embodiments of the present disclosure. The data center 900 can include a data center infrastructure layer 910, a framework layer 920, a software layer 930, and/or an application layer 940. In some embodiments, one or more of the components of the example data center 900 can implement one or more of the techniques described herein with respect to the method 200 of FIG. 2.

As shown in FIG. 9, the data center infrastructure layer 910 can include a resource orchestrator 912, grouped computing resources 914, and node computing resources (“node C.R.s”) 916(1)-916(N), where “N” represents any whole, positive integer. In at least one embodiment, node C.R.s 916(1)-916(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) can correspond to a server having one or more of the above-mentioned computing resources. In addition, in some embodiments, the node C.R.s 916(1)-9161(N) can include one or more virtual components, such as vGPUs, vCPUs, and/or the like, and/or one or more of the node C.R.s 916(1)-916(N) can correspond to a virtual machine (VM).

In at least one embodiment, grouped computing resources 914 can include separate groupings of node C.R.s 916 housed within one or more racks (not shown), or many racks housed in data centers at various geographical locations (also not shown). Separate groupings of node C.R.s 916 within grouped computing resources 914 can include grouped compute, network, memory or storage resources that can be configured or allocated to support one or more workloads. In at least one embodiment, several node C.R.s 916 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 912 can configure or otherwise control one or more node C.R.s 916(1)-916(N) and/or grouped computing resources 914. In at least one embodiment, resource orchestrator 912 can include a software design infrastructure (SDI) management entity for the data center 900. The resource orchestrator 912 can include hardware, software, or some combination thereof.

In at least one embodiment, as shown in FIG. 9, framework layer 920 can include a job scheduler 928, a configuration manager 934, a resource manager 936, and/or a distributed file system 938. The framework layer 920 can include a framework to support software 932 of software layer 930 and/or one or more application(s) 942 of application layer 940. The software 932 or application(s) 942 can respectively include web-based service software or applications, such as those provided by Amazon Web Services, Google Cloud and Microsoft Azure. The framework layer 920 can be, but is not limited to, a type of free and open-source software web application framework such as Apache Spark™ (hereinafter “Spark”) that can utilize distributed file system 938 for large-scale data processing (e.g., “big data”). In at least one embodiment, job scheduler 928 can include a Spark driver to facilitate scheduling of workloads supported by various layers of data center 900. The configuration manager 934 can be capable of configuring different layers such as software layer 930 and framework layer 920 including Spark and distributed file system 938 for supporting large-scale data processing. The resource manager 936 can be capable of managing clustered or grouped computing resources mapped to or allocated for support of distributed file system 938 and job scheduler 928. In at least one embodiment, clustered or grouped computing resources can include grouped computing resource 914 at data center infrastructure layer 910. The resource manager 936 can coordinate with resource orchestrator 912 to manage these mapped or allocated computing resources.

In at least one embodiment, software 932 included in software layer 930 can include software used by at least portions of node C.R.s 916(1)-916(N), grouped computing resources 914, and/or distributed file system 938 of framework layer 920. One or more types of software can include, but are not limited to, Internet web page search software, e-mail virus scan software, database software, and streaming video content software.

In at least one embodiment, application(s) 942 included in application layer 940 can include one or more types of applications used by at least portions of node C.R.s 916(1)-916(N), grouped computing resources 914, and/or distributed file system 938 of framework layer 920. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 can implement any number and type of self-modifying actions based at least on any amount and type of data acquired in any technically feasible fashion. Self-modifying actions can relieve a data center operator of data center 900 from making possibly bad configuration decisions and possibly avoiding underutilized and/or poor performing portions of a data center.

The data center 900 can include tools, services, software or other resources to train one or more machine learning models or predict or infer information using one or more machine learning models according to one or more embodiments described herein. For example, a machine learning model(s) can be trained by calculating weight parameters according to a neural network architecture using software and/or computing resources described above with respect to the data center 900. In at least one embodiment, trained or deployed machine learning models corresponding to one or more neural networks can be used to infer or predict information using resources described above with respect to the data center 900 by using weight parameters calculated through one or more training techniques, such as but not limited to those described herein.

In at least one embodiment, the data center 900 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 800 of FIG. 8—e.g., each device can include similar components, features, and/or functionality of the computing device(s) 800. In addition, where backend devices (e.g., servers, NAS, etc.) are implemented, the backend devices can be included as part of a data center 900, an example of which is described in more detail herein with respect to FIG. 9.

Components of a network environment can communicate with each other using a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments - in which case a server can not be included in a network environment—and one or more client-server network environments—in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications using one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 800 described herein with respect to FIG. 8. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
obtain image data associated with at least one image that includes one or more imperfections;
determine a query based at least on the at least one image, the query configured to prompt a vision language model (VLM) to generate an output indicative of the one or more imperfections of the at least one image;
provide the image data and the query to the VLM to prompt the VLM to generate the output; and
provide data on a degree of quality of the at least one image associated with the one or more imperfections, according to the output of the VLM.

2. The one or more processors of claim 1, wherein the one or more circuits are to:
determine a context based at least on a feature of the at least one image; and
wherein, to determine the query, the one or more circuits are to:
determine a set of strings associated with the context; and
determine the query based at least on the set of strings, the query configured to cause the VLM to generate the output to include a text string indicative of the feature.

3. The one or more processors of claim 2,
wherein the one or more circuits are to:
determine the context using a context for at least another image occurring prior to the at least one image in time or in a sequence.

4. The one or more processors of claim 1, wherein, to determine the query, the one or more circuits are to:
determine the query from a plurality of queries, where each of the queries is configured to cause the VLM to indicate a degradation from among a plurality of imperfections comprising noise, blur, distortion, artifacts, chromatic aberration, vignetting, or aliasing.

5. The one or more processors of claim 1, wherein each image of the at least one image comprises a two-dimensional (2D) image represented using a 2D array of pixels, each pixel associated with a first channel and a second channel; and
wherein, to determine the query based at least on the at least one image, the one or more circuits are to:
determine the query based at least on the first channel or the second channel.

6. The one or more processors of claim 5, wherein the first channel is associated with a first portion of an electromagnetic spectrum, and the second channel is associated with a second portion of the electromagnetic spectrum that is at least in part different from the first portion of the electromagnetic spectrum, and
wherein, to provide the image data and the query to the VLM, the one or more circuits are to:
provide a portion of the image data associated with the first channel or the second channel to the VLM to cause the VLM to generate the output.

7. The one or more processors of claim 1,
wherein, to determine the query, the one or more circuits are to:
determine the query based at least on annotations of the at least one image.

8. The one or more processors of claim 7, wherein each image of the at least one image is represented by a plurality of pixels, each pixel of the plurality of pixels associated with a first channel corresponding to pixel values and a second channel corresponding to annotations, and
wherein, to determine the query, the one or more circuits are to:
determine the query such that the query is configured to prompt the VLM to indicate mismatches between annotations indicative of segmentation errors.

9. The one or more processors of claim 1, wherein the query comprises a first query, the output comprises a first output, the one or more imperfections comprise one or more first imperfections, and
wherein the one or more circuits are to:
determine that the first output indicates that the at least one image comprises the one or more first imperfections;
determine a second query based at least on the one or more first imperfections, the second query configured to prompt the VLM to indicate that one or more second imperfections are present in the at least one image;
provide the image data and the second query to the VLM to cause the VLM to generate a second output, where the second output indicates that the at least one image includes the one or more second imperfections; and
determine the degree of quality associated with the at least one image according to the second output.

10. The one or more processors of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing large language models (LLMs);
a system for implementing small language models (SLMs);
a system for hosting one or more real-time streaming applications;
a system for performing light transport simulation;
a system for performing collaborative content creation for 3D assets; or
a system implemented at least partially using cloud computing resources.

11. A system comprising:
one or more processors to perform operations comprising:
receiving image data associated with at least one image that includes one or more imperfections;
determining a query based at least on the at least one image, the query configured to prompt a vision language model (VLM) to generate an output indicative of the one or more imperfections of the at least one image;
providing the image data and the query to the VLM to prompt the VLM to generate the output; and
providing data on a degree of quality of the at least one image associated with the one or more imperfections, according to the output of the VLM.

12. The system of claim 11, wherein the one or more processors are to perform the operation of:
determining a context based at least on a feature of the at least one image; and
wherein the one or more processors are to perform the operation of determining the query by:
determining a set of strings associated with the context; and
determining the query based at least on the set of strings, the query configured to cause the VLM to generate the output to include a text string indicative of the feature.

13. The system of claim 12, wherein the one or more processors that perform the operation of determining the context are to determine a context for at least another image occurring prior to the at least one image in time or in a sequence.

14. The system of claim 11, wherein the one or more processors are to perform the operation of determining the query by determining the query from a plurality of queries, where each of the queries is configured to cause the VLM to indicate a degradation from among a plurality of imperfections comprising: noise, blur, distortion, artifacts, chromatic aberration, vignetting, or aliasing.

15. The system of claim 11, wherein each image of the at least one image comprises a two-dimensional (2D) image represented using a 2D array of pixels, each pixel associated with a first channel and a second channel; and
wherein the one or more processors are to perform the operation of determining the query based at least on the at least one image by determining the query based at least on the first channel or the second channel.

16. The system of claim 15 wherein the first channel is associated with a first portion of an electromagnetic spectrum, and the second channel is associated with a second portion of the electromagnetic spectrum that is at least in part different from the first portion of the electromagnetic spectrum, and
wherein the one or more processors are to perform the operation of providing the image data and the query to the VLM by providing a portion of the image data associated with the first channel or the second channel to the VLM to cause the VLM to generate the output.

17. The system of claim 11, wherein the one or more processors are to perform the operation of determining the query by determining the query based at least on annotations of the at least one image.

18. The system of claim 17, wherein each image of the at least one image is represented by a plurality of pixels, each pixel of the plurality of pixels associated with a first channel corresponding to pixel values and a second channel corresponding to annotations; and
wherein the one or more processors are to perform the operation of determining the query by determining the query such that the query is configured to prompt the VLM to indicate mismatches between annotations indicative of segmentation errors.

19. The system of claim 11, wherein the system is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing large language models (LLMs);
a system for implementing small language models (SLMs);
a system for hosting one or more real-time streaming applications;
a system for performing light transport simulation;
a system for performing collaborative content creation for 3D assets; or
a system implemented at least partially using cloud computing resources.

20. A method comprising:
receiving image data associated with at least one image that includes one or more imperfections;
determining a query based at least on the at least one image, the query configured to prompt a vision language model (VLM) to generate an output indicative of the one or more imperfections of the at least one image;
providing the image data and the query to the VLM to prompt the VLM to generate the output; and
providing data on a degree of quality of the at least one image associated with the one or more imperfections, according to the output of the VLM.
